(19) United States
(12) Patent Application Publication
(10) Pub. No.: US 2019/0107436 A1
(43) Pub. Date: Apr. 11, 2019

(54) SPECTROSCOPIC DETECTION DEVICE, AND ADJUSTMENT METHOD FOR DETECTION TARGET WAVELENGTH RANGE

(71) Applicant: OLYMPUS CORPORATION, Tokyo (JP)

(72) Inventor: Masahito DOHI, Tokyo (JP)

(73) Assignee: OLYMPUS CORPORATION, Tokyo (JP)

(21) Appl. No.: 16/151,248

(22) Filed: Oct. 3, 2018

(30) Foreign Application Priority Data
Oct. 10, 2017 (JP) 2017-196918

(51) Int. Cl. G01J 3/02; G01J 3/06; G01J 3/44

(52) U.S. Cl. CPC G01J 3/0235; G01J 3/0229; G01J 2003/062; G01J 3/4406; G01J 3/06

(57) ABSTRACT

A spectroscopic detection device includes a laser light source configured to emit a laser beam, an objective configured to irradiate a sample with the laser beam, a scanner arranged in an illumination optical path between the laser light source and the objective, a light detector configured to detect light from the sample, a plurality of optical filters arranged in a detection optical path between the objective and the light detector, and a driving device. The driving device rotates the plurality of optical filters in such a manner that at least one of the optical filters has its rotational axis in a direction different from a rotational axis of the other optical filter.

### CROSS REFERENCE TO RELATED APPLICATIONS

This application is based upon and claims the benefit of priority from prior Japanese Patent Application No. 2017-196918, filed Oct. 10, 2017, the entire contents of which are incorporated herein by this reference.

### BACKGROUND OF THE INVENTION

### Field of the Invention

The disclosure of the present specification is related to a spectroscopic detection device and an adjustment method for a detection target wavelength range.

### Description of the Related Art

Spectroscopic units used for spectroscopic detection devices are roughly classified into dispersive elements such as for example a prism and a diffractive grating and into wavelength selective filters such as for example a dichroic filter (a dichroic mirror) and a barrier filter.

Spectroscopic detection devices using dispersive elements (which will be referred to as dispersive-element-type spectroscopic detection devices) can perform multi-channel detection with a wavelength resolution higher than that of spectroscopic detection devices using wavelength selective filters (which will be referred to as filter-type spectroscopic detection devices). Dispersive-element-type spectroscopic detection devices have an advantage of the ability to easily change the detection-target wavelength range. However, they have a problem in which they cannot treat a broad wavelength range because the diffraction efficiency greatly differs between different wavelengths.

Meanwhile, filter-type spectroscopic detection devices, having wavelength selective filters with high transmissivity for light in the detection-target wavelength range, can achieve detection efficiency higher than that of dispersive-element-type spectroscopic detection devices. However, filter-type spectroscopic detection devices have a problem in which they lack wavelength selectivity.

The above two approaches respectively have their own advantages and disadvantages. Japanese Patent No. 2733491 discloses a technique that can achieve both high wavelength selectivity and high detection efficiency, which are the advantages respectively of the above two approaches. The device described in Japanese Patent No. 2733491 is provided with an interference filter that can rotate about the axis orthogonal to the optical axis. According to this device, the transmission wavelength can be changed by adjusting the rotation angle of the interference filter.

### SUMMARY OF THE INVENTION

A spectroscopic detection device according to an aspect of the present invention includes a laser light source configured to emit a laser beam, an objective configured to irradiate a sample with the laser beam, a scanner arranged in an illumination optical path between the laser light source and the objective, alight detector configured to detect light from the sample, a plurality of optical filters arranged in a detection optical path between the objective and the light detector, and a driving device configured to rotate each of the plurality of optical filters in such a manner that at least one of the plurality of the optical filters has its rotational axis in a direction different from a rotational axis of the other optical filter.

An adjustment method according to an aspect of the present invention is an adjustment method for a detection target wavelength range of a spectroscopic detection device, the adjustment method including obtaining information on the detection target wavelength range, and rotating, according to the obtained information, each of a plurality of optical filters in such a manner that at least one of the plurality of the optical filters has its rotational axis in a direction different from a rotational axis of the other optical filter.

### BRIEF DESCRIPTION OF THE DRAWINGS

The present invention will be more apparent from the following detailed description when the accompanying drawings are referenced.

FIG. 1 exemplifies the configuration of a spectroscopic detection device 100 of the first embodiment;

FIG. 2 exemplifies the hardware configuration of a control device 40;

FIG. 3A and FIG. 3B exemplify the configuration of the driving device 21, FIG. 3A illustrating a driving device 21 seen in the y-axis direction and FIG. 3B illustrating the driving device 21 seen in the x-axis direction;

FIG. 4A and FIG. 4B explain a shift of the light flux through an optical filter, FIG. 4A illustrating the light flux seen in the y-axis direction and FIG. 4B illustrating the light flux seen in the z-axis direction;

FIG. 5 explains a shift amount of the light flux;

FIG. 6 explains an adjustment method for a detection target wavelength range;

FIG. 7 illustrates an example of a flowchart of a detection-target-wavelength-range adjustment process;

FIG. 8 is another diagram explaining the adjustment method for a detection target wavelength range;

FIG. 9 exemplifies the configuration of a filter switching device;

FIG. 10 illustrates another example of the flowchart of the detection-target-wavelength-range adjustment process;

FIG. 11 explains the arrangement of flare stops; and

FIG. 12 exemplifies the configuration of a spectroscopic detection device 200 of the present embodiment.

### DESCRIPTION OF THE EMBODIMENTS

In the device described in Japanese Patent No. 2733491, the light flux shifts by the amount according to the rotation angle when it is transmitted through the interference filter. Thus, a structure that corrects shifts of light flux occurring according to the rotation angle is provided. Structures such as this hinder the downsizing of the device, and may reduce the detection efficiency.

According to the device disclosed in Japanese Patent No. 2733491, light fluxes enter the interference filter at different angles for different image heights. As a result, light in different wavelengths is transmitted through the interference filter for different image heights, resulting in wavelengths in different ranges being transmitted through the interference filter for different image heights. This hinders the capability to treat a wider field of view.

In view of the above situation, there is a demand for a new technique that enables a spectroscopic detection device to achieve both the wavelength selectivity and the detection efficiency at a high level. Hereinafter, the embodiments of the present invention will be explained.

### First Embodiment

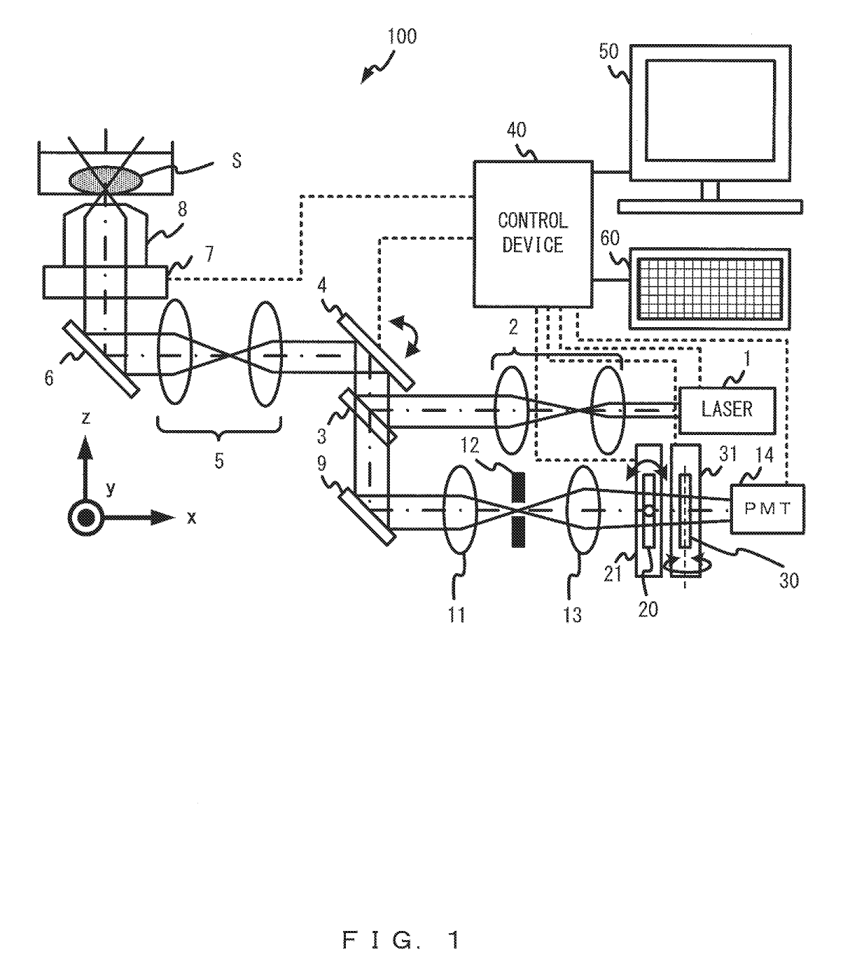

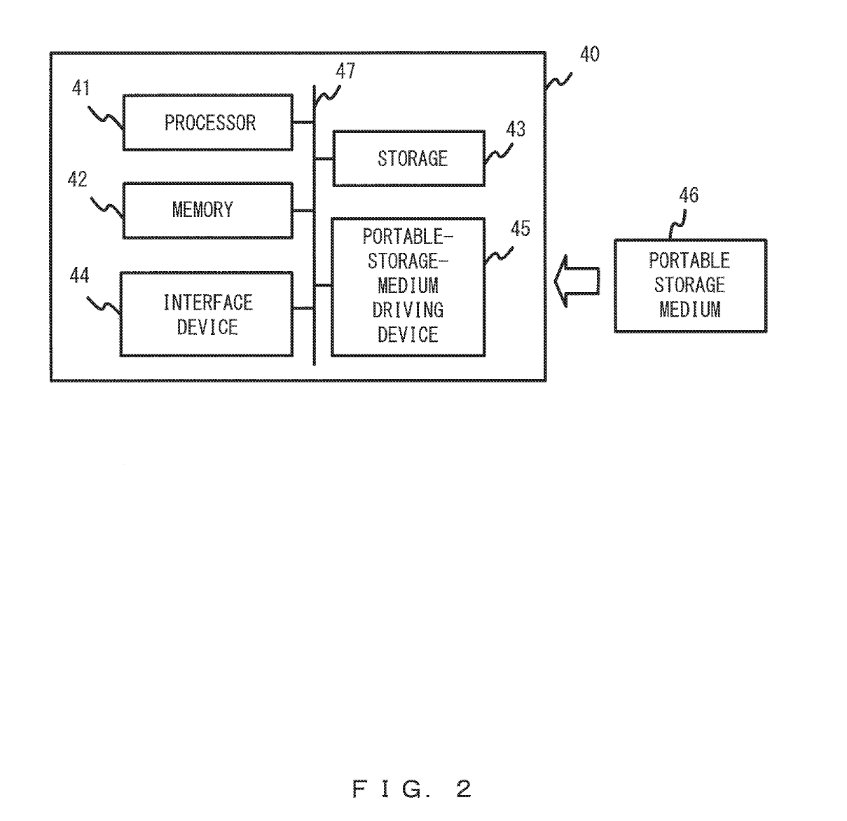

FIG. 1 exemplifies the configuration of a spectroscopic detection device 100 of the present embodiment. FIG. 2 exemplifies the hardware configuration of a control device 40. The spectroscopic detection device 100 is a confocal microscope device, which is a type of laser scanning microscope (LSM) devices, and is for example a fluorescence microscope. As illustrated in FIG. 1, the spectroscopic detection device 100 includes a microscope device body, the control device 40, a display device 50, and an input device 60.

The microscope device body includes a laser light source 1 that emits a laser beam, an objective 8 that irradiates sample S with the laser beam, and a photomultiplier (PMT) 14 that detects the light from sample S. The microscope device body includes, on the illumination optical path between the laser light source 1 and the objective 8, a beam expander 2, a dichroic mirror 3, a scanner 4, a relay optical system 5, and a mirror 6. Also, on the detection optical path between the objective 8 and the PMT 14, the microscope device body includes a mirror 9, a lens 11, a confocal diaphragm 12, a lens 13, and a plurality of optical filters (an optical filter 20 and an optical filter 30) in addition to the above dichroic mirror 3, the scanner 4, the relay optical system 5, and the mirror 6. The microscope device body further includes a focusing device 7 and driving devices (a driving device 21 and a driving device 31) that rotate the plurality of optical filters.

The laser light source 1 is for example a laser light source that emits a laser beam in the visible wavelength range or the ultraviolet wavelength range. Note that the microscope device body may include a plurality of laser light sources including the laser light source 1. Also, the plurality of laser light sources may be connected to a laser combiner.

The beam expander 2 adjusts the light flux diameter of the laser beam emitted from the laser light source 1. The dichroic mirror 3 is an optical-path branching element having a spectral characteristic that reflects a laser beam and transmits fluorescence radiated from sample S.

The scanner 4 is a 2D scanning device that two-dimensionally scans sample S with a laser beam, and is arranged in the illumination optical path between the laser light source 1 and the objective 8. In more detail, the scanner 4 is arranged in the illumination optical path. The position in which the scanner 4 is arranged is also in the detection optical path between the objective 8 and the PMT 14. The scanner 4 includes for example a galvanometer scanner and a resonant scanner. The scanner 4 may include two galvanometer scanners.

The relay optical system 5 is an optical system that projects the image of the scanner 4 to a spot near the pupil position of the objective 8. The mirror 6 is a reflection member that reflects, in the optical axis direction of the objective 8, the laser beam transmitted through the relay optical system 5.

The focusing device 7 changes the distance between the objective 8 and sample S. The focusing device 7 changes the distance between the objective 8 and sample S by for example moving the objective 8 in the optical axis directions of the objective 8. The focusing device 7 may move a stage (not illustrated) on which sample S is mounted in the optical axis directions of the objective 8.

The objective 8 is for example an infinity-corrected microscope objective, and may include a correction collar. Also, the objective 8 may be a dry objective or may be an immersion objective. Note that the microscope device body may include a plurality of objectives including the objective 8.

The plurality of objectives may be attached to a revolver (not illustrated).

The lens 11 is arranged in such a manner that the focal plane of the lens 11 is on the confocal diaphragm 12. The confocal diaphragm 12 includes an aperture that is arranged at a position optically conjugate with the front-side focal position of the objective 8. The lens 13 guides, to the PMT 14, the fluorescence that has passed through the confocal diaphragm 12. The optical elements arranged in the detection optical path, starting from the objective 8 to the lens 13, constitute a confocal optical system.

The PMT 14 is an example of a light detector. The microscope device body may include, instead of the PMT 14, a different light detector such as for example an avalanche photodiode (APD), etc.

The optical filters 20 and 30 and the driving devices 21 and 31 will be described later.

The control device 40 controls the units belonging to the spectroscopic detection device 100. The control device 40 may be included in the microscope device body. The control device 40 may include a microcomputer, an FPGA, or the like included in the microscope device body. The control device 40 may be a standard computer, and may be connected to the microscope device body in a wired or wireless manner.

FIG. 2 exemplifies the hardware configuration of the control device 40. As illustrated in for example FIG. 2, the control device 40 includes a processor 41, a memory 42, a storage 43, an interface device 44, and a portable-storage-medium driving device 45, into which a portable storage medium 46 is inserted. These constituents are interconnected via a bus 47. Note that FIG. 2 illustrates an example of the hardware configuration of the control device 40, to which the control device 40 is not limited.

The processor 41 is for example a central processing unit (CPU), a micro processing unit (MPU), a digital signal processor (DSP), etc., and executes a program so as to perform the programmed process such as for example a detection-target-wavelength-range adjustment process, which will be described later. The memory 42 is for example a random access memory (RAM), and temporarily stores a program or data recorded in the storage 43 or the portable storage medium 46. The storage 43 is for example a hard disk or a flash memory, and mainly records various types of data and a program. The interface device 44 is a circuit that exchanges a signal with a device other than the control device 40, such as for example the microscope device body, the display device 50, the input device 60, etc. The portable-storage-medium driving device 45 accommodates the portable storage medium 46 such as for example an optical disk and a compact flash (registered trademark). The portable storage medium 46 assists the storage 43.

The display device 50 is for example a liquid crystal display, but may be an organic electro-luminescence display (OLED), a cathode-ray tube (CRT) display, etc. The display device 50 displays various information including an image obtained by the spectroscopic detection device 100 and a setting window in which the detection target wavelength is set.

The input device 60 is for example a keyboard, but maybe a mouse, a joystick, a touch panel, etc. The input device 60 outputs a signal according to a manipulation made by the user on the control device 40.

In the spectroscopic detection device 100, the control device 40 controls the laser light source 1, and thereby the laser light source 1 emits a laser beam having a prescribed wavelength and a prescribed intensity. Thereafter, the light flux diameter of the laser beam emitted from the laser light source 1 is adjusted by the beam expander 2. Then, the laser beam is reflected by the dichroic mirror 3, and enters the scanner 4. The laser beam deflected by the scanner 4 in a direction according to the scanning angle passes through the relay optical system 5, the mirror 6, and the objective 8 so that sample S is irradiated with the laser beam.

The control device 40 controls the scanner 4 so as to move the focal position of the laser beam on the focal plane of the objective 8 in the x-axis direction and the y-axis direction, which are orthogonal to the optical axis of the objective 8. Thereby, sample S is two-dimensionally scanned with the laser beam. While raster scanning is employed as an example of a scanning method widely used by a confocal microscope device, the two-dimensional scanning method for the scanner 4 is not limited.

Sample S irradiated with the laser beam radiates fluorescence. The fluorescence radiated from sample S passes through the objective 8, the mirror 6, the relay optical system 5, and the scanner 4 so as to enter and be transmitted through the dichroic mirror 3. The fluorescence transmitted through the dichroic mirror 3 passes through the mirror 9 so as to enter the lens 11, and is condensed by the refractive power of the lens 11.

The confocal diaphragm 12, which is provided at a stage subsequent to the lens 11, includes an aperture at a position optically conjugate with the front-side focal position of the objective 8. Thereby, the part of the fluorescence radiated from sample S passes through the aperture of the confocal diaphragm 12, and the part is radiated from the focal position of the laser beam on the focal plane of the objective 8. The rest of the fluorescence is blocked by the confocal diaphragm 12.

The fluorescence that has passed through the confocal diaphragm 12 is cast onto the optical filters 20 and 30 by the lens 13. Because the optical filters 20 and 30 block part of the incident fluorescence that is outside a prescribed detection target wavelength range, the fluorescence in the detection target wavelength range enters the PMT 14 and is detected. Note that the detection target wavelength range is a wavelength range of light in which the spectroscopic detection device 100 performs detection.

The PMT 14 outputs an analog signal in a size according to the amount of the received light. The analog signal output from the PMT 14 is sampled on the basis of a synchronization signal output from the scanner 4, and is output to the control device 40 as a digital luminance signal. The control device 40 constructs a confocal image of sample S on the basis of the luminance signal.

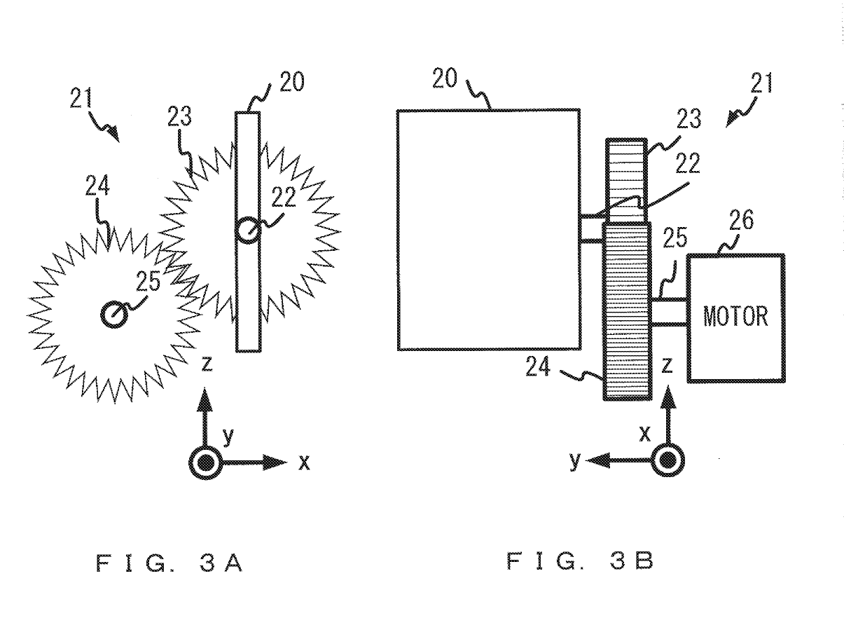

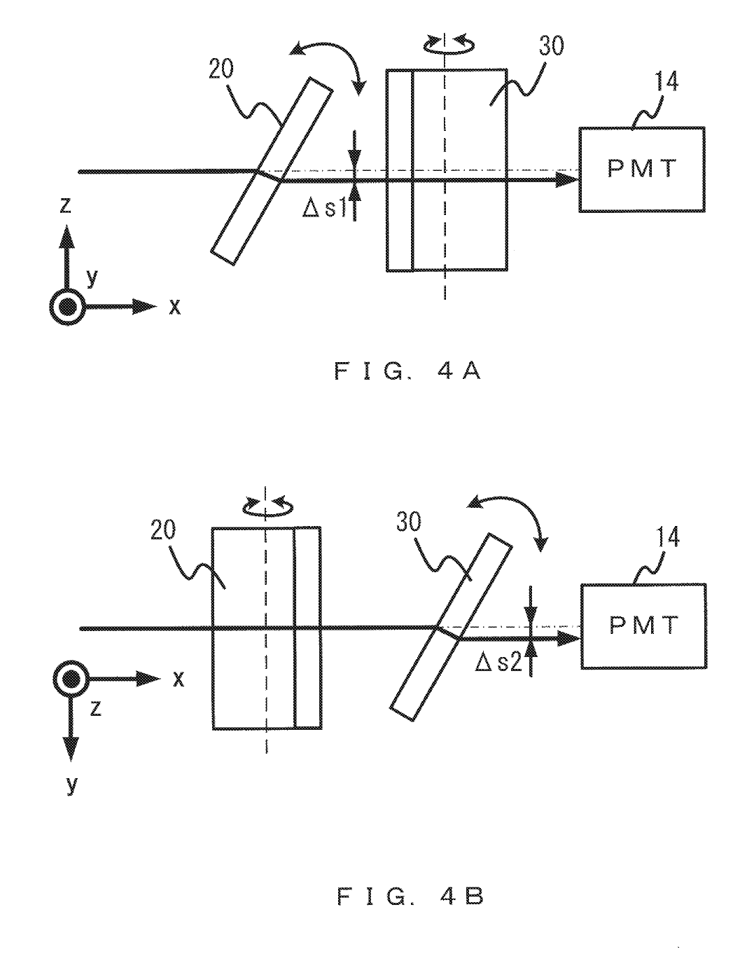

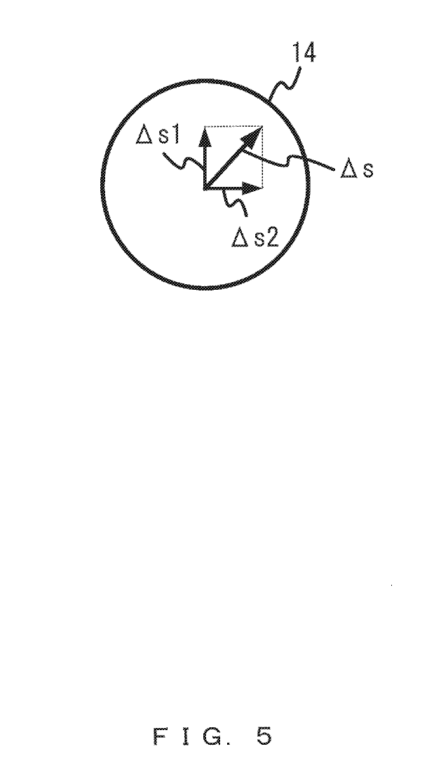

FIG. 3A and FIG. 3B exemplify the configuration of the driving device 21 included in the spectroscopic detection device 100. FIG. 4A and FIG. 4B explain a shift of the light flux through an optical filter. FIG. 5 explains a shift amount of the light flux. The following explains the optical filters 20 and 30 and the driving devices 21 and 31 by referring to FIG. 1 and FIG. 3A through FIG. 5.

The optical filters 20 and 30 are optical elements having optical characteristics (which will be hereinafter referred to as incident angle spectral characteristics) that vary according to the incident angle. The optical filters 20 and 30 are tunable filters having transmission wavelength ranges with high transmissivity, and are designed to allow the continuous changes of the transmission wavelength ranges depending on the incident angles but to maintain high transmissivity of the transmission wavelength ranges regardless of the incident angle.

The optical filters 20 and 30 are for example interference filters having a dielectric multilayer. While the optical filters 20 and 30 may be edge filters or bandpass filters, they are desirably edge filters, and more desirably a pair of a low-pass filter and a high-pass filter. It is also desirable that the optical filters 20 and 30 have incident angle spectral characteristics that are different from each other.

The optical filters 20 and 30 are arranged in the detection optical path between the objective 8 and the PMT 14. More specifically, the optical filters 20 and 30 are arranged in the detection optical path between the confocal diaphragm 12 and the PMT 14 so as to have an effect on the light that has passed through the confocal diaphragm 12. Arranging the optical filters 20 and 30 in the detection optical path between the confocal diaphragm 12 and the PMT 14 enables the spectroscopic detection device 100 to cause a confocal effect without being influenced by a shift of the light flux, which will be described later.

Further, the optical filters 20 and 30 are rotatably provided in the detection optical path, and rotate on the rotational axes that are in different directions from each other. For example, the optical filters 20 and 30 are arranged in the detection optical path in such a manner that they rotate respectively on the y and z axes as illustrated in FIG. 1. Note that the optical filters 20 and 30 are connected respectively to the driving devices 21 and 31, and rotate on their own rotational axes by being powered by these driving devices.

The driving devices 21 and 31 respectively rotate the optical filters 20 and 30. While FIG. 1 illustrates an example in which the microscope device body includes a driving device for each optical filter, the microscope device body may include a single driving device that rotates a plurality of optical filters in an independent manner.

The driving device 21 appearing in FIG. 3A and FIG. 3B is an example of a driving device that rotates the optical filter 20. FIG. 3A illustrates the driving device 21 seen in the y-axis direction. FIG. 3B illustrates the driving device 21 seen in the x-axis direction. Note that the driving device 31 also has a similar configuration, although not appearing in the figures.

The driving device 21 includes a shaft 22, which is fixed to the optical filter 20 and serves as the rotational axis of the optical filter 20, a gear 23 fixed to the shaft 22, a gear 24 that engages with the gear 23, a shaft 25 fixed to the gear 24, and a motor 26 that rotates the shaft 25.

The motor 26 is for example a stepping motor that operates under control of a pulse signal from the control device 40. The operation of the motor 26 conveys the rotation of the shaft 25 to the shaft 22 through a gear train (the gear 23 and the gear 24). This rotates the optical filter 20, changing the incident angle of the fluorescence entering the optical filter 20.

As illustrated in FIG. 4A and FIG. 4B, the refraction on the surfaces of the optical filters 20 and 30 shifts the light flux in a direction orthogonal to the optical axis. FIG. 4A illustrates the optical filter 20 shifting the light flux, and FIG. 4B illustrates the optical filter 30 shifting the light flux.

When the optical filters 20 and 30 shift the light flux in the same direction, there is a possibility that shift amount Δs2, which is caused by the optical filter 30, will be simply added to shift amount Δs1, which is caused by the optical filter 20. This easily increases combined shift amount Δs, which is caused by the optical filters 20 and 30. When, by contrast, the optical filters 20 and 30 shift the light flux in different directions, combined shift amount Δs in the PMT 14 can be suppressed to a relatively small amount as illustrated in FIG. 5.

The directions of the rotational axes of the optical filters 20 and 30 determine the directions in which the optical filters 20 and 30 shift the light flux. Specifically, the light flux is shifted in a direction orthogonal to both the rotational-axis direction of the optical filter and the traveling direction of the incident light (fluorescence). In other words, different rotational axis directions of the optical filters 20 and 30 can make the two filters shift the light flux in different directions when the incident light travels in the same directions through the filters.

In view of this fact, the spectroscopic detection device 100 causes the driving devices 21 and 31 to rotate the optical filters 20 and 30 so that the optical filters 20 and 30 will have the rotational axes in different directions. This can suppress combined shift amount As to a relatively small amount.

For example, the driving device 21 rotates the optical filter 20 in such a manner that the optical filter 20 has its rotational axis in the y-axis direction. Also, the driving device 31 rotates the optical filter 30 in such a manner that the optical filter 30 has its rotational axis in the z-axis direction. As described above, causing the optical filters 20 and 30 to have their respective rotational axes orthogonal to each other can minimize combined shift amount Δs.

Also, when the optical filters 20 and 30 have their respective rotational axes in the same direction, multiple reflection can easily occur between the optical filters 20 and 30. These optical filters are set to have inclinations that lead to an excellent spectral characteristic for the incident light substantially parallel to the optical axis of the lens 13. However, the multiply reflected incident light can enter the optical filters at various incident angles. This leads to a possibility that light outside the detection target wavelength range will pass through the optical filters, deteriorating the optical density for the wavelength (wavelength of non-detection target wavelength range) that should be blocked.

The optical filters 20 and 30 having different rotational axes can suppress multiple reflection, enabling the improvement of the optical density for light in the non-detection target wavelength range.

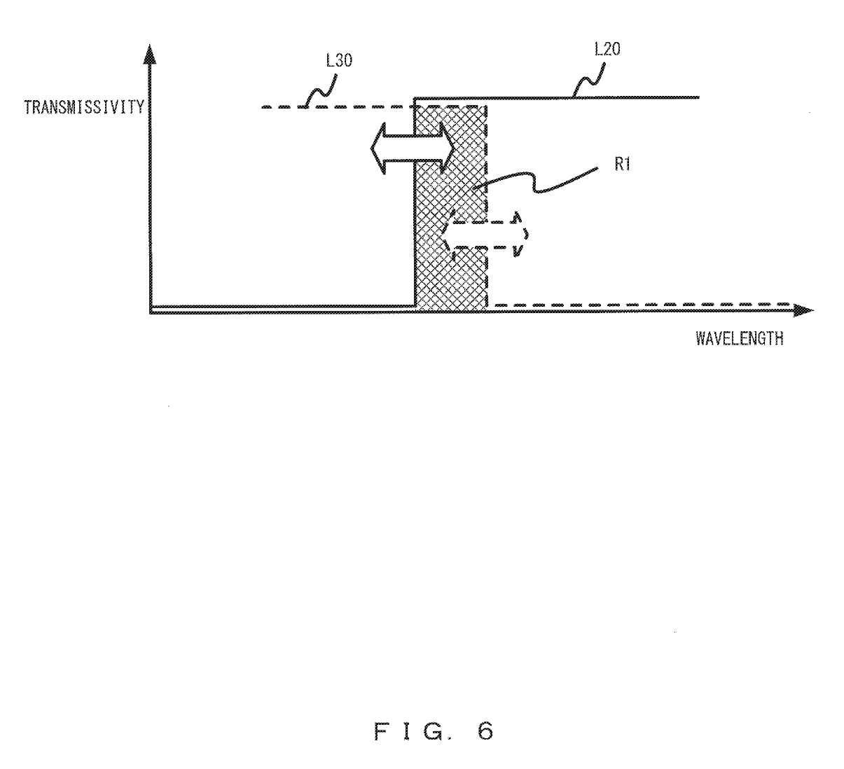

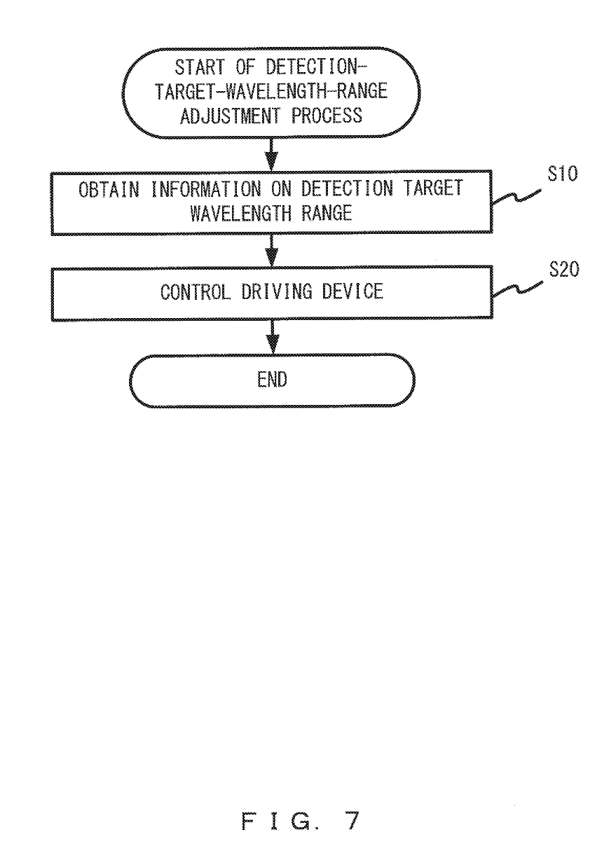

FIG. 6 explains an adjustment method for a detection target wavelength range. FIG. 7 illustrates an example of a flowchart of a detection-target-wavelength-range adjustment process. The following explains an adjustment method for a detection target wavelength range performed by the spectroscopic detection device 100.

The control device 40 in the spectroscopic detection device 100 first obtains information on detection target wavelength range (step S10) in response to the start of the detection-target-wavelength-range adjustment process illustrated in FIG. 7. In this step, for example the user of the spectroscopic detection device 100 specifies a detection target wavelength range through the input device 60 while referring to the setting window that the display device 50 displays. The control device 40 may obtain information about a detection target wavelength range on the basis of an input from the input device 60. The control device 40 may also obtain information about a detection target wavelength range by reading the contents of the setting file from a storage area.

After obtaining the information about a detection target wavelength range, the control device 40 controls the driving devices 21 and 31 on the basis of the obtained information (step S20). In an example with the optical filter 20 serving as a high-pass filter and the optical filter 30 serving as a low-pass filter, the control device 40 first makes the driving device 21 rotate the optical filter 20 to change the spectral characteristic of the optical filter 20 for the incident light in such a manner that the cutoff wavelength (edge wavelength) of the optical filter 20 is equal to the lower limit of the detection target wavelength range. The control device 40 then makes the driving device 31 rotate the optical filter 30 to change the spectral characteristic of the optical filter 30 for the incident light in such a manner that the cutoff wavelength (edge wavelength) of the optical filter 30 is equal to the upper limit of the detection target wavelength range. Note that lines L20 and L30 illustrated in FIG. 6 respectively represent the spectral characteristics of the optical filters 20 and 30.

Thereby, combined transmission wavelength range R1 of the optical filters 20 and 30 can be attained that coincides with the detection target wavelength range as illustrated in FIG. 6, range R1 being between the cutoff wavelengths of the optical filters 20 and 30. Note that the combined transmission wavelength range is a wavelength range in which the transmission wavelength ranges of the optical filters 20 and 30 overlap each other.

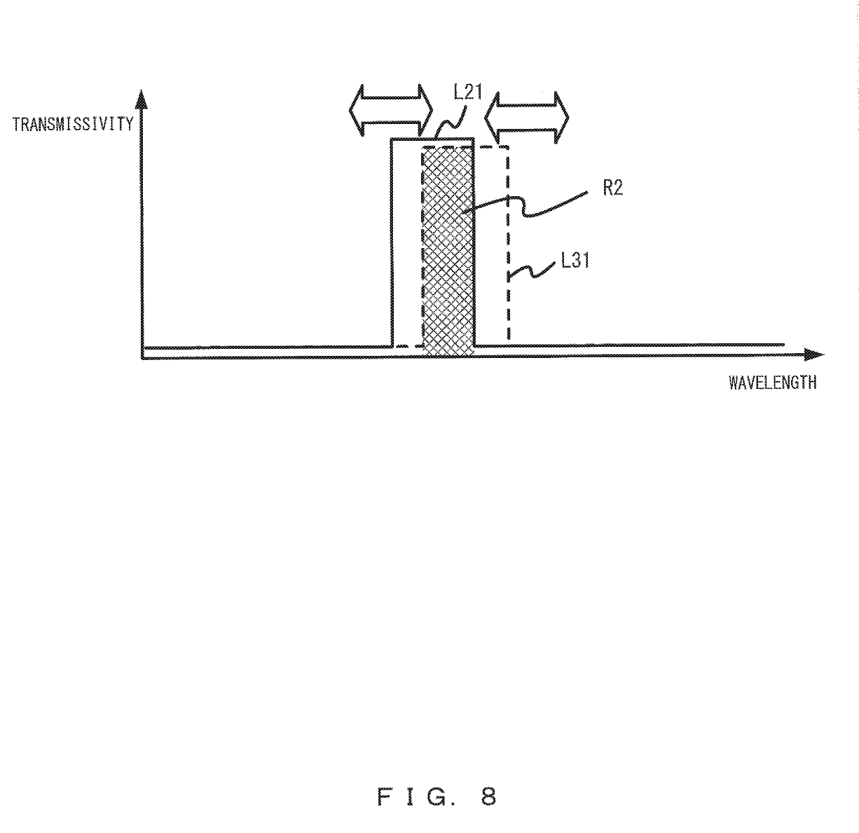

FIG. 8 is another diagram explaining an adjustment method for a detection target wavelength range to be used in a case where the optical filters 20 and 30 are bandpass filters. While FIG. 6 illustrates an example in which the optical filters are edge filters, the optical filters may be bandpass filters as illustrated in FIG. 8. When the optical filters are bandpass filters, the driving devices are controlled so that one (the optical filter 20 in this example) of the filters has its upper-limit cutoff wavelength equal to the upper limit of the detection target wavelength range and the other (the optical filter 30 in this example) has its lower-limit cutoff wavelength equal to the lower limit of the detection target wavelength range.

This can attain combined transmission wavelength range R2 of the optical filters 20 and 30 that coincides with the detection target wavelength range as illustrated in FIG. 8, range R2 being between the lower-limit cutoff wavelength of the optical filter 30 and the higher-limit cutoff wavelength of the optical filter 20. Note that lines L21 and L31 appearing in FIG. 8 respectively represent the spectral characteristics of the optical filters 20 and 30.

However, when bandpass filters are used as the optical filters, the bandwidths of the optical filters limit the width of the combined transmission wavelength range. Thus, the optical filters are desirably edge filters because the width of the detection target wavelength range is independent from the bandwidths of the optical filters.

As described above, the spectroscopic detection device 100 includes a plurality of optical filters (the optical filters 20 and 30) that are rotatably arranged in the detection optical path and that has a transmission wavelength range with high transmissivity, and rotates these optical filters according to the detection target wavelength range so as to adjust the incident angle of the detection target light (fluorescence). This enables the combined transmission wavelength range of a plurality of optical filters to coincide with the detection target wavelength range. Thus, the spectroscopic detection device 100 can achieve both high wavelength selectivity and high detection efficiency.

Also, the spectroscopic detection device 100 includes driving devices (the driving devices 21 and 31) that respectively rotate a plurality of optical filters in such a manner that the optical filters have their respective rotational axes in different directions. Thereby, the optical filters shift the light flux in different directions, enabling the suppression of the amount of shifts occurring in the PMT 14. Contrary to a microscope device that projects an image of the sample onto the 2D image sensor so as to obtain the image (this type of a microscope device will be hereinafter referred to as a wide-field microscope device), the spectroscopic detection device 100, which is a laser scanning microscope device, does not allow a shift, which may occur in the light flux, to affect the detection result as long as the light flux enters the PMT 14. This can suppress the shift amount to a level that permits the entry of the detection target light to the PMT 14, enabling the omission of a structure (corrector plate for example) that the conventional devices included in the detection optical paths for correcting a shift of the light flux. This can avoid a light amount loss that would be caused by a corrector plate etc. Thereby, the spectroscopic detection device 100 can achieve detection efficiency higher than those achieved by the conventional devices.

Also, the spectroscopic detection device 100, which is a confocal microscope device, includes the scanner 4 arranged in the detection optical path and in the illumination optical path. Thereby, the detection target light (fluorescence) can enter a plurality of optical filters at a roughly consistent angle regardless of the image height (scanning position). Thus, the spectroscopic detection device 100 can treat a wider field of view because a combined transmission wavelength range does not depend on an image height, contrary to wide-field microscope devices, which have different combined transmission wavelength ranges for different images.

Further, the spectroscopic detection device 100 includes the control device 40 that controls the driving devices 21 and 31 to rotate the optical filters 20 and 30, and thereby causes the combined transmission wavelength range to coincide with the detection target wavelength range. The above automated adjustment of the optical filters can prevent the user from performing an inappropriate setting. An inappropriate setting can easily occur particularly in an environment with a plurality of users sharing a device. Thus, the above automated operation is effective particularly in an environment with a plurality of users sharing the spectroscopic detection device 100.

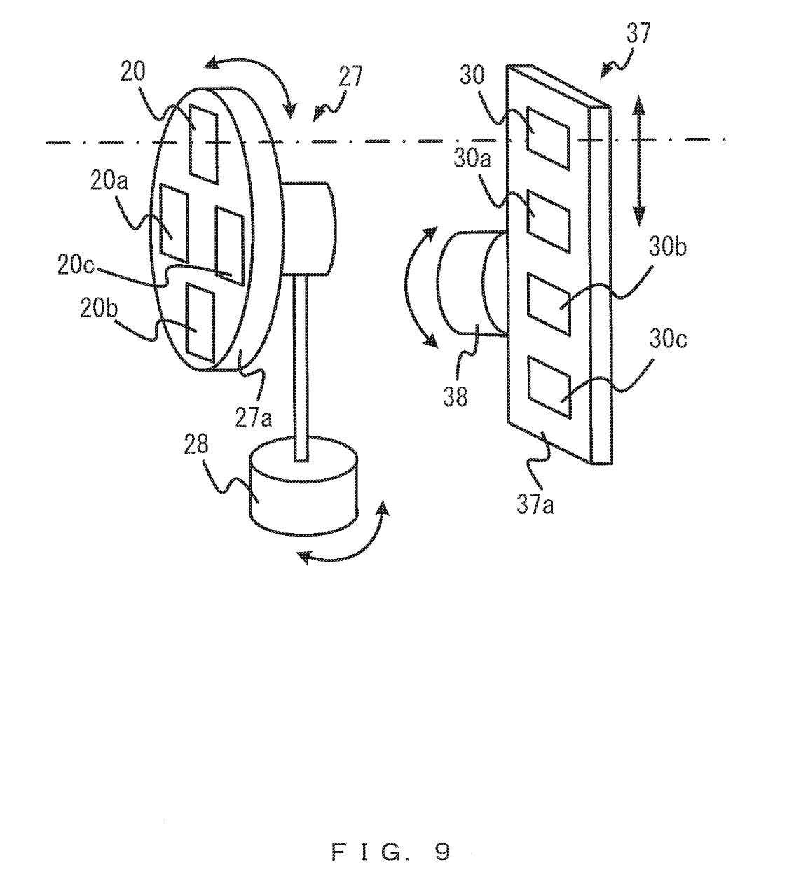

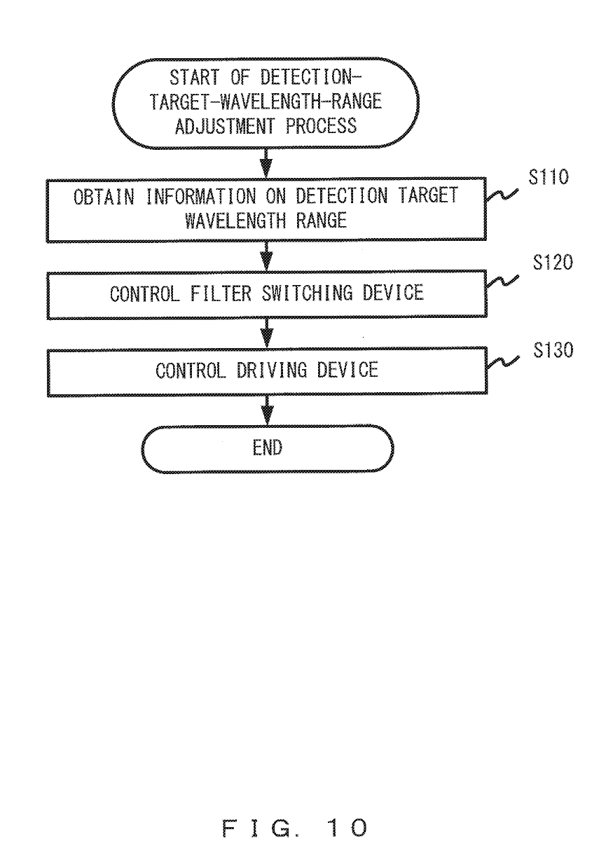

FIG. 9 exemplifies the configuration of a filter switching device. FIG. 10 illustrates another example of the flowchart of the detection-target-wavelength-range adjustment process. The following explains a variation example of the spectroscopic detection device 100 by referring to FIG. 9 and FIG. 10.

The spectroscopic detection device of the present variation example differs from the spectroscopic detection device 100 in including filter switching devices 27 and 37 respectively in place of the driving devices 21 and 31. The spectroscopic detection device is similar to the spectroscopic detection device 100 in the other aspects.

The filter switching device 27 switches the optical filter arranged in the detection optical path from the optical filter 20 to another optical filter (such as optical filters 20a through 20c) having a different incident angle spectral characteristic. The filter switching device 27 includes a rotary disk 27a that rotates about the rotational axis parallel to the optical axis so that one of the plurality of optical filters arranged on the rotary disk 27a is brought into the detection optical path. The filter switching device 27 also includes a driving device 28 that rotates about the rotational axis orthogonal to the optical axis. The driving device 28 rotates about the rotational axis orthogonal to the optical axis so as to rotate the optical filter (the optical filter 20 in this example) arranged in the detection optical path, and thereby the incident angle of the detection target light changes.

The filter switching device 37 switches the optical filter arranged in the detection optical path from the optical filter 30 to another optical filter (such as optical filters 30a through 30c) having a different incident angle spectral characteristic. The filter switching device 37 includes a slider 37a that moves in the directions orthogonal to the optical axis so that one of the plurality of optical filters arranged on the slider 37a is brought into the detection optical path. The filter switching device 37 also includes a driving device 38 that rotates about the rotational axis orthogonal to the optical axis. The driving device 38 rotates about the rotational axis orthogonal to the optical axis so as to rotate the optical filter (the optical filter 30 in this example) arranged in the detection optical path, and thereby the incident angle of the detection target light changes.

Note that the driving devices 28 and 38 are arranged in such a manner that they rotate optical filters about different rotational axes.

The control device 40 in the spectroscopic detection device of the present variation example first obtains information on the detection target wavelength range (step S110) in response to the start of the detection-target-wavelength-range adjustment process illustrated in FIG. 10. This process is similar to the process in step S10 illustrated in FIG. 7.

The control device 40 then controls the filter switching devices (step S120). The control device 40 controls the filter switching devices 27 and 37 on the basis of the information on the detection target wavelength range obtained in step S110, and arranges optical filters on the detection optical path according to the detection target wavelength range. Specifically, the filter switching device 27 rotates the rotary disk 27a in such a manner that an optical filter arranged in the detection optical path will have a transmission wavelength range with high transmissivity for the detection target wavelength range. Also, the filter switching device 37 moves the slider 37a in such a manner that an optical filter arranged in the detection optical path will have a transmission wavelength range with high transmissivity for the detection target wavelength range.

Lastly, the control device 40 controls the driving devices 28 and 38 (step S130) on the basis of the information obtained in step S110. This process is similar to the process in step S20 illustrated in FIG. 7 except that the driving devices 28 and 38 are controlled in place of the driving devices 21 and 31.

The above process can cause the combined transmission wavelength range of a plurality of optical filters to coincide with the detection target wavelength range. Accordingly, the spectroscopic detection device of the present variation example as well can achieve an effect similar to that achieved by the spectroscopic detection device 100.

The spectroscopic detection device of the present variation example also includes the plurality of filter switching devices (the filter switching devices 27 and 37) that switch the plurality of optical filters arranged in the detection optical path respectively from the optical filters 20 and 30 to other optical filters (such as the optical filters 20a through 20c and the optical filters 30a through 30c) having different incident angle spectral characteristics. The control device 40 controls the plurality of filter switching devices (the filter switching devices 27 and 37) according to the obtained information on the detection target wavelength range.

While a single optical filter can only treat a limited wavelength range, the spectroscopic detection device of the present variation example, in which a plurality of optical filters are switched according to the detection target wavelength range and arranged on the detection optical path, can treat a broader wavelength range than that of the spectroscopic detection device 100. This enables the spectroscopic detection device of the present variation example to achieve wavelength selectivity higher than that of the spectroscopic detection device 100.

Also, the spectroscopic detection device of the present variation example includes the control device 40 that controls the filter switching devices 27 and 37 to switch optical filters to be arranged in the detection optical path. The automated switching operation of the optical filters can prevent the user from performing an inappropriate setting. An inappropriate setting can easily occur particularly in an environment with a plurality of users sharing a device, and thus this automated operation is effective particularly when a plurality of users share the spectroscopic detection device.

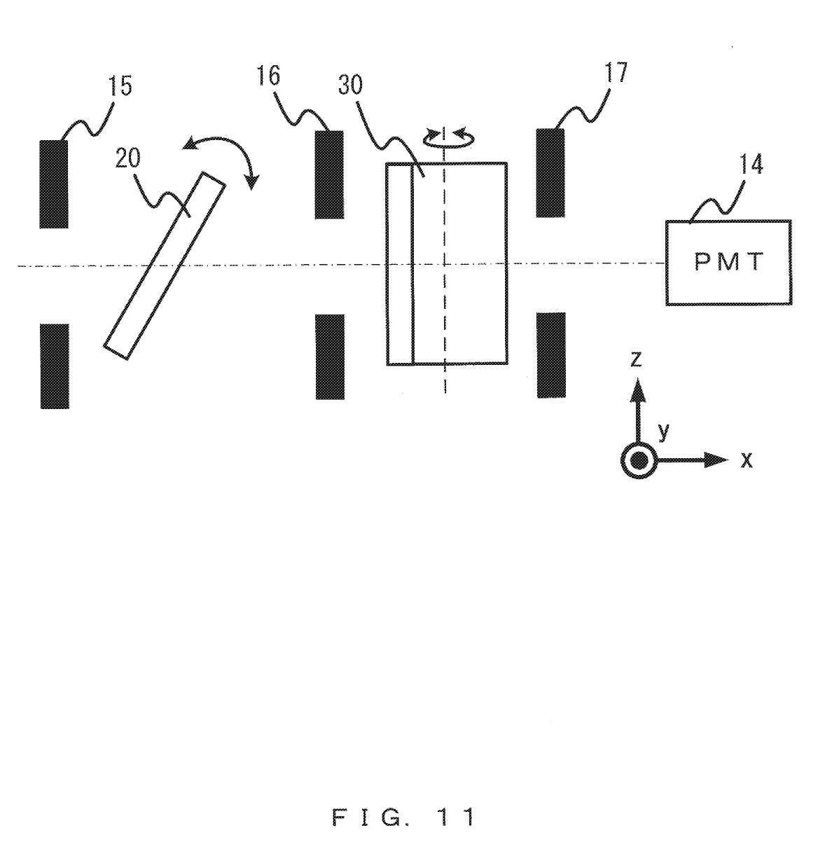

FIG. 11 explains the arrangement of flare stops. The following explains another variation example (second variation example) of the spectroscopic detection device 100 by referring to FIG. 11.

As illustrated in FIG. 11, the spectroscopic detection device of the second variation example differs from the spectroscopic detection device 100 in including a plurality of flare stops (fare stops 15 through 17) in the detection optical path. The spectroscopic detection device of the second variation example is similar to the spectroscopic detection device 100 in the other aspects.

As described above, the optical filters 20 and 30 are adjusted in such a manner that the combined transmission wavelength range coincides with the detection target wavelength range for light entering parallel to the optical axis. However, stray light appearing in the detection optical path may enter the optical filter (the optical filter 20 or 30) at various angles, preventing sufficient blockage by the optical filter.

The spectroscopic detection device of the second variation example as well can achieve an effect similar to that achieved by the spectroscopic detection device 100. Also, the plurality of flare stops arranged in the detection optical path can block stray light in the spectroscopic detection device of the second variation example. Accordingly, the spectroscopic detection device of the second variation example can improve the optical density for light outside the detection target wavelength range better than the spectroscopic detection device 100.

While FIG. 11 illustrates an example in which a plurality of flare stops are arranged in the detection optical path, any other numbers of flare stops may be arranged in the detection optical path. A single flare stop may be arranged in the detection optical path. In that case, the flare stop is desirably arranged between the optical filters 20 and 30 like for example the flare stop 16. This is because a flare stop between the optical filters 20 and 30 can block most of stray light even in the presence of multiple reflection, which can easily occur between the optical filters 20 and 30.

### Second Embodiment

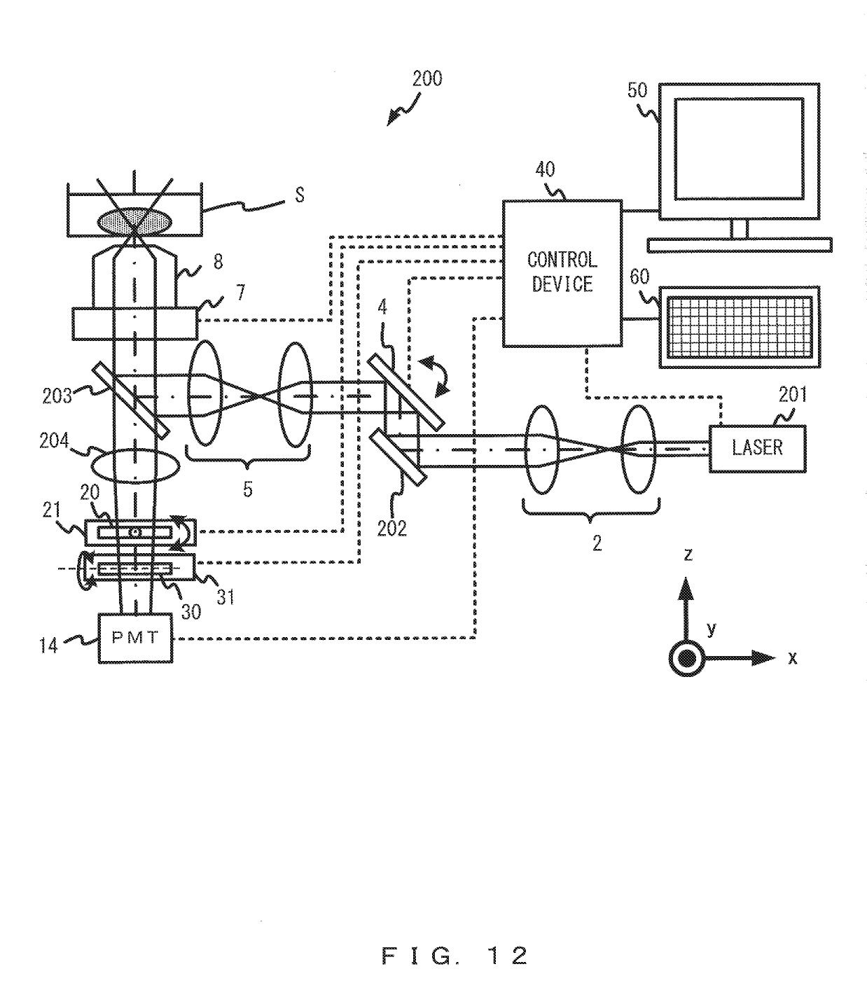

FIG. 12 exemplifies the configuration of a spectroscopic detection device 200 of the present embodiment. The spectroscopic detection device 200 is a multiphoton excitation microscope device, which is a type of laser scanning microscope (LSM) devices. The spectroscopic detection device 200 includes a microscope device body, the control device 40, the display device 50, and the input device 60 as illustrated in FIG. 12. The spectroscopic detection device 200 has a configuration similar to that of the spectroscopic detection device 100 except that the microscope device body of the spectroscopic detection device 200 has a configuration different from that of the spectroscopic detection device 100. Note that like constituents are denoted by like numerals between the spectroscopic detection device 200 and the spectroscopic detection device 100.

The microscope device body includes a laser light source 201 that emits a laser beam, the objective 8 that irradiates sample S with the laser beam, and the photomultiplier (PMT) 14 that detects the light from sample S. The laser light source 201 is for example an ultrashort-pulse laser that emits an infrared laser beam having a pulse width in the order of picoseconds or femtoseconds.

The microscope device body also includes the beam expander 2, a mirror 202, the scanner 4, the relay optical system 5, and a dichroic mirror 203 in the illumination optical path between the laser light source 201 and the objective 8. The dichroic mirror 203 is an optical-path branching element having a spectral characteristic that reflects a laser beam and transmits fluorescence radiated from sample S.

The microscope device body further includes a lens 204 and a plurality of optical filters (the optical filters 20 and 30) in addition to the above dichroic mirror 203 in the detection optical path between the objective 8 and the PMT 14. The lens 204 guides, to the PMT 14, the fluorescence that has been transmitted through the dichroic mirror 203 after being taken in by the objective 8.

The microscope device body further includes the focusing device 7 and driving devices (the driving devices 21 and 31) that respectively rotate a plurality of optical filters.

In the spectroscopic detection device 200, the control device 40 controls the laser light source 201 so that the laser light source 201 emits a laser beam having a prescribed wavelength and a prescribed intensity. Thereafter, the laser beam emitted from the laser light source 201 has its light flux diameter adjusted by the beam expander 2, is reflected by the mirror 202, and enters the scanner 4. The laser beam deflected by the scanner 4 in a direction according to the scanning angle passes through the relay optical system 5, the dichroic mirror 203, and the objective 8 so that sample S is irradiated with the laser beam.

The control device 40 controls the scanner 4 so as to move the focal position of the laser beam on the focal plane of the objective 8 in the x-axis direction and the y-axis direction, which are orthogonal to the optical axis of the objective 8, and thereby sample S is two-dimensionally scanned by the laser beam.

Sample S being irradiated with the laser beam simultaneously absorbs a plurality of photons at the focal position of the laser beam having a high photon density, and fluorescence is generated only at that position.

The fluorescence scattered in sample S is taken in by the objective 8, is transmitted by the dichroic mirror 203, and enters the lens 204. The fluorescence that has entered the lens 204 is cast by the lens 204 onto the optical filters 20 and 30.

Similar to those in the spectroscopic detection device 100, the optical filters 20 and 30 block part of the incident fluorescence that is outside a prescribed detection target wavelength range, and thereby the fluorescence in the detection target wavelength range enters the PMT 14 and is detected.

The PMT 14 outputs an analog signal in a size according to the amount of the received light. The analog signal output from the PMT 14 is sampled on the basis of a synchronization signal output from the scanner 4, and is output to the control device 40 as a digital luminance signal. The control device 40 constructs an image of sample S on the basis of the luminance signal.

Similarly to the spectroscopic detection device 100, the spectroscopic detection device 200 of the present embodiment as well can cause the combined transmission wavelength range to coincide with the detection target wavelength range by performing the detection-target-wavelength-range adjustment process illustrated in FIG. 7. Thus, the spectroscopic detection device 200 can achieve both wavelength selectivity and detection efficiency at a high level similarly to the spectroscopic detection device 100.

Also, the spectroscopic detection device 200 as well prevents a shift, which may occur in the light flux, from affecting the detection result as long as the light flux enters the PMT 14, similarly to the spectroscopic detection device 100. This enables the omission of a structure (corrector plate for example) that corrects a shift of the light flux, avoiding a light amount loss that would be caused by a corrector plate etc. Thereby, the spectroscopic detection device 200 can achieve detection efficiency higher than those achieved by the conventional devices, similarly to the spectroscopic detection device 100.

Also, in the spectroscopic detection device 200, which is a multiphoton excitation microscope device, fluorescence is generated only at the focal position, but is scattered in sample S. This causes the fluorescence to be taken in by the entire field of view substantially regardless of the focal position (image height). Thereby, the optical filters operate under roughly the same condition for the fluorescence from any focal position (image height), eliminating the dependency of the combined transmission wavelength range on the image height almost completely. Thus, similarly to the spectroscopic detection device 100, the spectroscopic detection device 200 as well can treat a wide field of view, which a wide-field microscope device with different combined transmission wavelength ranges for different image heights fails to treat.

Further, in the spectroscopic detection device 200 as well, the control device 40 controls the driving devices 21 and 31 so as to rotate the optical filters 20 and 30 to cause the combined transmission wavelength range to coincide with the detection target wavelength range. Accordingly, the spectroscopic detection device 200 is similar to the spectroscopic detection device 100 also in the ability to prevent the user from performing an inappropriate setting.

As described above, the spectroscopic detection device 200 as well can achieve an effect similar to that achieved by the spectroscopic detection device 100. Differently from the case of confocal microscope devices, a dispersive element cannot be easily used for a multiphoton excitation microscope, in which there is no pinhole or a slit and a light flux relatively large in diameter passes through the detection optical path from the objective 8 to the PMT 14. The spectroscopic detection device 200, which uses a tunable filter for a multiphoton excitation microscope, is very advantageous in view of this point, and can achieve both wavelength selectivity and detection efficiency at a level higher than that achieved by the conventional multiphoton excitation microscopes.

Note that the spectroscopic detection device 200 as well allows various changes similarly to the spectroscopic detection device 100. The spectroscopic detection device 200 may include for example the filter switching devices 27 and 37 illustrated in FIG. 9 in place of the driving devices 21 and 31, and may perform the detection-target-wavelength-range adjustment process illustrated in FIG. 10. Thereby, the spectroscopic detection device 200 can treat a broad wavelength range, achieving still higher wavelength selectivity.

As illustrated in FIG. 11, the spectroscopic detection device 200 may include a plurality of flare stops (the flare stops 15 through 17) on the detection optical path, and may include the flare stop 16 between the plurality of optical filters. This enables the blockage of stray light, leading to further improvement in the optical density for light outside the detection target wavelength range.

The above embodiments of the present invention are specific examples provided for facilitating understanding of the invention, and are not limited to these examples. The spectroscopic detection devices allow various modifications and changes without departing from the descriptions in the claims.

While the above embodiments describe examples in which the spectroscopic detection device includes two optical filters, any number greater than one of optical filters (including three or more optical filters) maybe included. When the spectroscopic detection device includes three or more optical filters, the driving devices rotate the optical filters in such a manner that at least one of the optical filters has its rotational axis in a direction different from the rotational axes of the other optical filters. Also, the plurality of optical filters include at least two edge filters and particularly that such at least two edge filters include a low-pass filter and a high-pass filter. Also, when a flare stop is provided, the flare stop is desirably arranged between two of the plurality of optical filters arranged in the detection optical path.

What is claimed is:

1. A spectroscopic detection device comprising:
a laser light source configured to emit a laser beam;
an objective configured to irradiate a sample with the laser beam;
a scanner arranged in an illumination optical path between the laser light source and the objective;
a light detector configured to detect light from the sample;
a plurality of optical filters arranged in a detection optical path between the objective and the light detector; and
a driving device configured to rotate each of the plurality of optical filters in such a manner that at least one of the plurality of the optical filters has its rotational axis in a direction different from a rotational axis of the other optical filter.

2. The spectroscopic detection device according to claim 1, further comprising
a control device, wherein
the control device
obtains information on a detection target wavelength range, and
controls the driving device according to the obtained information.

3. The spectroscopic detection device according to claim 2, further comprising
a plurality of filter switching devices, each of a plurality of filter switching devices being configured to switch each of the plurality of optical filters arranged in the detection optical path to different optical filters having incident angle spectral characteristics different from those of the optical filters to be switched.

4. The spectroscopic detection device according to claim 3, wherein
the control device controls the plurality of filter switching devices according to the obtained information.

5. The spectroscopic detection device according to claim 1, wherein
the plurality of optical filters include at least two edge filters.

6. The spectroscopic detection device according to claim 2, wherein
the plurality of optical filters include at least two edge filters.

7. The spectroscopic detection device according to claim 3, wherein
the plurality of optical filters include at least two edge filters.

8. The spectroscopic detection device according to claim 4, wherein
the plurality of optical filters include at least two edge filters.

9. The spectroscopic detection device according to claim 5, wherein
the at least two edge filters include a low-pass filter and a high-pass filter.

10. The spectroscopic detection device according to claim 6, wherein
the at least two edge filters include a low-pass filter and a high-pass filter.

11. The spectroscopic detection device according to claim 7, wherein
the at least two edge filters include a low-pass filter and a high-pass filter.

12. The spectroscopic detection device according to claim 8, wherein
the at least two edge filters include a low-pass filter and a high-pass filter.

13. The spectroscopic detection device according to claim. 1, further comprising
a flare stop, the flare stop being arranged between two of the plurality of optical filters arranged in the detection optical path.

14. The spectroscopic detection device according to claim. 2, further comprising
a flare stop, the flare stop being arranged between two of the plurality of optical filters arranged in the detection optical path.

15. The spectroscopic detection device according to claim. 3, further comprising
a flare stop, the flare stop being arranged between two of the plurality of optical filters arranged in the detection optical path.

16. The spectroscopic detection device according to claim. 4, further comprising
a flare stop, the flare stop being arranged between two of the plurality of optical filters arranged in the detection optical path.

17. The spectroscopic detection device according to claim. 5, further comprising
a flare stop, the flare stop being arranged between two of the plurality of optical filters arranged in the detection optical path.

18. The spectroscopic detection device according to claim. 1, further comprising
a confocal optical system including a confocal diaphragm, wherein
the plurality of optical filters are arranged in the detection optical path between the confocal diaphragm and the light detector, and
the spectroscopic detection device is a confocal microscope device.

19. The spectroscopic detection device according to claim. 1, wherein
the laser light source is an ultrashort-pulse laser, and
the spectroscopic detection device is a multiphoton excitation microscope device.

20. An adjustment method for a detection target wavelength range of a spectroscopic detection device, the adjustment method comprising:
obtaining information on the detection target wavelength range, and
rotating, according to the obtained information, each of a plurality of optical filters in such a manner that at least one of the plurality of optical filters has its rotational axis in a direction different from a rotational axis of the other optical filter.
